(19) United States
(12) Patent Application Publication
(10) Pub. No.: US 2025/0005781 A1
(43) Pub. Date: Jan. 2, 2025

(54) Distance Measurement Method

(71) Applicants: BEIJING BOE TECHNOLOGY DEVELOPMENT CO., LTD., Beijing (CN); BOE TECHNOLOGY GROUP CO., LTD., Chaoyang District, Beijing (CN)

(72) Inventor: Qian Ha, Beijing (CN)

(21) Appl. No.: 18/704,993

(22) PCT Filed: Aug. 17, 2022
(86) PCT No.: PCT/CN2022/113071

§ 371 Date: Apr. 26, 2024

(51) Int. Cl. G06T 7/70; G06T 7/11

(52) U.S. Cl. CPC G06T 7/70; G06T 7/11

(57) ABSTRACT

A distance measurement method includes obtaining an image to be detected, the image to be detected including at least one object to be detected; obtaining a reference region and a region of an object to be detected based on the image to be detected; obtaining a reference line based on the reference region, the reference line being used to locate the reference region; obtaining a positioning line based on the region of the object to be detected, the positioning line being used to locate the region of the object to be detected; and obtaining a distance between the region of the object to be detected and the reference region based on the reference line and the positioning line.

### CROSS-REFERENCE TO RELATED APPLICATION

This application is the United States national phase of International Patent Application No. PCT/CN2022/113071, filed Aug. 17, 2022, the disclosure of which is hereby incorporated by reference in its entirety.

### BACKGROUND OF THE INVENTION

### Field of the Invention

The present disclosure relates to the field of image processing technologies, and in particular, to a distance measurement method.

### Description of Related Art

Among the multiple processes in the production line of the array substrates, one process is to measure the distance of multiple detection objects.

### SUMMARY OF THE INVENTION

In an aspect, a distance measurement method is provided. The distance measurement method includes: obtaining an image to be detected, the image to be detected including at least one object to be detected; obtaining a reference region and a region of an object to be detected based on the image to be detected; obtaining a reference line based on the reference region, the reference line being used to locate the reference region; obtaining a positioning line based on the region of the object to be detected, the positioning line being used to locate the region of the object to be detected; obtaining a distance between the region of the object to be detected and the reference region based on the reference line and the positioning line.

In some embodiments, the reference line is parallel to a first direction; obtaining the reference line based on the reference region includes: selecting a plurality of first positioning points in the reference region; and obtaining the reference line based on coordinate values of the plurality of first positioning points in a second direction, the second direction being perpendicular to the first direction, and a coordinate value of the reference line in the second direction being an average of the coordinate values of the plurality of first positioning points in the second direction.

In some embodiments, selecting the plurality of first positioning points in the reference region includes: selecting a plurality of first calibration points on a contour of the reference region, the plurality of first calibration points being respectively located at top, bottom, and at least one intermediate position between the top and bottom of the contour of the reference region; obtaining a first straight line parallel to the second direction based on each first calibration point; and obtaining a respective first positioning point of the plurality of first positioning points based on a line segment of the first straight line in the reference region, the first positioning point being a midpoint of the line segment of the first straight line in the reference region.

In some embodiments, the region of the object to be detected includes at least two sub-regions.

In some embodiments, the positioning line is parallel to a first direction; the region of the object to be detected includes a first sub-region and a second sub-region; the positioning line includes a first positioning sub-line and a second positioning sub-line, the first positioning sub-line is used to locate the first sub-region, and the second positioning sub-line is used to locate the second sub-region. Obtaining the positioning line based on the region of the object to be detected includes: selecting a plurality of first positioning sub-points in the first sub-region; obtaining the first positioning sub-line based on coordinate values of the plurality of first positioning sub-points in a second direction, the second direction being perpendicular to the first direction, and a coordinate value of the first positioning sub-line in the second direction being an average of the coordinate values of the plurality of first positioning sub-points in the second direction; selecting a plurality of second positioning sub-points in the second sub-region; and obtaining the second positioning sub-line based on coordinate values of the plurality of second positioning sub-points in the second direction, a coordinate value of the second positioning sub-line in the second direction being an average of the coordinate values of the plurality of second positioning sub-points in the second direction.

In some embodiments, obtaining the distance between the region of the object to be detected and the reference region based on the reference line and the positioning line includes: obtaining a distance between the first positioning sub-line and the reference line based on the first positioning sub-line and the reference line; obtaining a distance between the second positioning sub-line and the reference line based on the second positioning sub-line and the reference line; and obtaining the distance between the region of the object to be detected and the reference region based on the distance between the first positioning sub-line and the reference line and the distance between the second positioning sub-line and the reference line.

In some embodiments, the positioning line is parallel to a first direction; obtaining the positioning line based on the region of the object to be detected includes: selecting a plurality of second positioning points in the region of the object to be detected; and obtaining the positioning line based on coordinate values of the plurality of second positioning points in a second direction, the second direction being perpendicular to the first direction, and a coordinate value of the positioning line in the second direction being an average of the coordinate values of the plurality of second positioning points in the second direction.

In some embodiments, obtaining the reference region based on the image to be detected includes: performing a binarization processing on the image to be detected to obtain the reference region.

In some embodiments, obtaining the region of the object to be detected based on the image to be detected includes: processing the image to be detected based on a neural network algorithm to obtain the region of the object to be detected.

In some embodiments, a region of the at least one object to be detected is located on a same side of the reference region.

In another aspect, a distance measurement apparatus is provided. The distance measurement apparatus includes: an image obtaining device and an image processing device. The image obtaining device is coupled to the image processing device and configured to obtain an image to be detected; the image to be detected includes at least one object to be detected. The image processing device is configured to: obtain a reference region and a region of an object to be detected based on the image to be detected; obtain a reference line based on the reference region, the reference line being used to locate the reference region; obtain a positioning line based on the region of the object to be detected, the positioning line being used to locate the region of the object to be detected; and obtain a distance between the region of the object to be detected and the reference region based on the reference line and the positioning line.

In some embodiments, the reference line is parallel to a first direction, and the image processing device is configured to: firstly, select a plurality of first positioning points in the reference region; and then, obtain the reference line based on coordinate values of the plurality of first positioning points in a second direction. The second direction is perpendicular to the first direction, and a coordinate value of the reference line in the second direction is an average of the coordinate values of the plurality of first positioning points in the second direction.

In some embodiments, the image processing device is configured to: firstly, select a plurality of first calibration points on a contour of the reference region, the plurality of first calibration points being respectively located at top, bottom, and at least one intermediate position between the top and bottom of the contour of the reference region; secondly, obtain a first straight line parallel to the second direction based on each first calibration point; and then, obtain a first positioning point based on a line segment of the first straight line in the reference region, the first positioning point being a midpoint of the line segment of the first straight line in the reference region.

In some embodiments, the region of the object to be detected includes at least two sub-regions.

In some embodiments, the positioning line is parallel to a first direction; the region of the object to be detected includes a first sub-region and a second sub-region; the positioning line includes a first positioning sub-line and a second positioning sub-line, the first positioning sub-line is used to locate the first sub-region, and the second positioning sub-line is used to locate the second sub-region. The image processing device is configured to: firstly, select a plurality of first positioning sub-points in the first sub-region; secondly, obtain the first positioning sub-line based on coordinate values of the plurality of first positioning sub-points in a second direction, a coordinate value of the first positioning sub-line in the second direction being an average of the coordinate values of the plurality of first positioning sub-points in the second direction; then, select a plurality of second positioning sub-points in the second sub-region; and then, obtain the second positioning sub-line based on coordinate values of the plurality of second positioning sub-points in the second direction, a coordinate value of the second positioning sub-line in the second direction being an average of the coordinate values of the plurality of second positioning sub-points in the second direction.

In some embodiments, the image processing device is configured to: firstly, obtain a distance between the first positioning sub-line and the reference line based on the first positioning sub-line and the reference line; secondly, obtain a distance between the second positioning sub-line and the reference line based on the second positioning sub-line and the reference line; and then, obtain the distance between the region of the object to be detected and the reference region based on the distance between the first positioning sub-line and the reference line and the distance between the second positioning sub-line and the reference line.

In some embodiments, the reference line is parallel to a first direction, and the image processing device is configured to: firstly, select a plurality of second positioning points in the region of the object to be detected; and then, obtain the positioning line based on coordinate values of the plurality of second positioning points in a second direction. The second direction is perpendicular to the first direction; a coordinate value of the positioning line in the second direction is an average of the coordinate values of the plurality of second positioning points in the second direction.

In some embodiments, the image processing device is configured to perform a binarization processing on the image to be detected to obtain the reference region.

In some embodiments, the image processing device is configured to obtain the region of the object to be detected based on the image to be detected and a neural network algorithm.

In some embodiments, a region of the at least one object to be detected is located on a same side of the reference region.

In yet another aspect, a non-transitory computer-readable storage medium is provided. The computer-readable storage medium has stored thereon computer program instructions that, when executed on a computer (e.g., a distance measurement apparatus), cause the computer to perform the distance measurement method according to any of the above embodiments.

In yet another aspect, a computer program product is provided. The computer program product is stored on a non-transitory computer-readable storage medium and includes computer program instructions, and when the computer program instructions are executed on a computer (e.g., a distance measurement apparatus), the computer program instructions cause the computer to perform the distance measurement method according to the above embodiments.

In yet another aspect, a computer program is provided. When executed by a computer (e.g., a distance measurement apparatus), the computer program causes the computer to perform the distance measurement method as described in the above embodiments.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a flow diagram of a distance measurement method, in accordance with some embodiments;

FIG. 2 is a schematic diagram of an image to be detected, in accordance with some embodiments;

FIG. 3 is a flow diagram of another distance measurement method, in accordance with some embodiments;

FIG. 4 is a schematic diagram of a reference region, first calibration points, first positioning points and a reference line, in accordance with some embodiments;

FIG. 5 is a flow diagram of yet another distance measurement method, in accordance with some embodiments;

FIG. 6A is a schematic diagram of a region of an object to be detected and sub-regions of the region of the object to be detected, in accordance with some embodiments;

FIG. 6B is a schematic diagram of another region of an object to be detected and sub-regions of the region of the object to be detected, in accordance with some embodiments;

FIG. 6C is a schematic diagram of yet another region of an object to be detected and sub-regions of the region of the object to be detected, in accordance with some embodiments;

FIG. 7 is a flow diagram of yet another distance measurement method, in accordance with some embodiments;

FIG. 8A is a schematic diagram of a first sub-region, a first positioning sub-line, and first positioning sub-points, in accordance with some embodiments;

FIG. 8B is another schematic diagram of a first sub-region, a first positioning sub-line, first positioning sub-points, and second calibration points, in accordance with some embodiments;

FIG. 9 is a schematic diagram of a second sub-region, a second positioning sub-line and a distance between the second sub-region and a reference region, in accordance with some embodiments;

FIG. 10 is a schematic diagram of a third sub-region, a third positioning sub-line and a distance between the third sub-region and a reference region, in accordance with some embodiments;

FIG. 11 is a schematic diagram of a fourth sub-region, a fourth positioning sub-line and a distance between the fourth sub-region and a reference region, in accordance with some embodiments;

FIG. 12 is a schematic diagram of a fifth sub-region, a fifth positioning sub-line and a distance between the fifth sub-region and a reference region, in accordance with some embodiments;

FIG. 13 is a flow diagram of yet another distance measurement method, in accordance with some embodiments; and

FIG. 14 is a structural diagram of a distance measurement apparatus, in accordance with some embodiments.

### DESCRIPTION OF THE INVENTION

The technical solutions in some embodiments of the present disclosure will be described clearly and completely with reference to the accompanying drawings;

obviously, the described embodiments are merely some but not all of embodiments of the present disclosure. All other embodiments obtained on a basis of the embodiments of the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics described herein may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of” or “the plurality of” means two or more unless otherwise specified.

Some embodiments may be described using the terms “coupled” and “connected” and their derivatives. For example, the term “connected” may be used in the description of some embodiments to indicate that two or more components are in direct physical or electrical contact with each other. As another example, the term “connected” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the context herein.

The phrase “applicable to” or “configured to” used herein has an open and inclusive meaning, which does not exclude devices that are applicable to or configured to perform additional tasks or steps.

In addition, the use of the phrase “based on” or “according to” is meant to be open and inclusive, since a process, step, calculation or other action that is “based on” or “according to” one or more of the stated conditions or values may, in practice, be based on or according to additional conditions or values exceeding those stated.

The terms “parallel”, “perpendicular” and “equal” as used herein include the stated conditions and the conditions similar to the stated conditions, and the range of the similar conditions is within the acceptable deviation range, where the acceptable deviation range is determined by a person of ordinary skill in the art in consideration of the measurement in question and the error associated with the measurement of a specific quantity (i.e., the limitation of the measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be, for example, that a difference between two equals is less than or equal to 5% of either of the two equals.

Exemplary embodiments are described herein with reference to cross-sectional views and/or plan views as idealized exemplary drawings. In the accompanying drawings, thicknesses of layers and sizes of regions may be exaggerated for clarity. Variations in shapes with respect to the drawings due to, for example, manufacturing technologies and/or tolerances may be conceivable. Therefore, the exemplary embodiments should not be construed as being limited to the shapes of the regions shown herein, but including shape deviations due to, for example, manufacturing. For example, an etched region shown as a rectangle generally has a curved feature. Therefore, the regions shown in the drawings are schematic in nature, and their shapes are not intended to show the actual shapes of the regions of the device, and are not intended to limit the scope of the exemplary embodiments.

Generally, in the production line of array substrates, the process of measuring distances of multiple detection objects requires the use of a microscope to magnify the detection objects and manual measurement, which results in low measurement efficiency and accuracy.

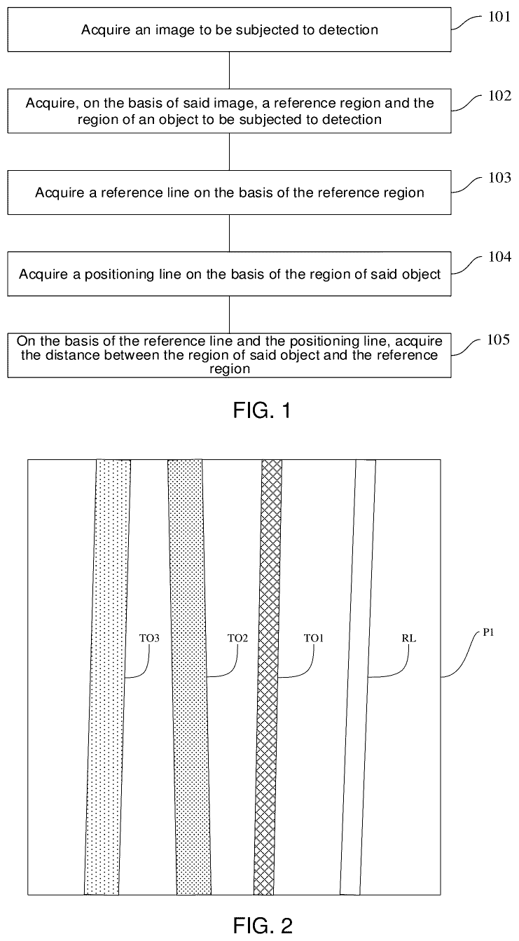

In light of this, some embodiments of the present disclosure provide a distance measurement method. As shown in FIG. 1, the method includes steps 101 to 105.

In step 101, an image to be detected is obtained.

The image to be detected includes at least one object to be detected. For example, an object to be detected may be an adhesive in the array substrate. The number of objects to be detected included in the image to be detected is not limited in the present disclosure. For example, as shown in FIG. 2, the image to be detected P1 includes three objects to be detected, and the three objects to be detected are respectively an object to be detected TO1, an object to be detected TO2 and an object to be detected TO3. It will be understood that since the actual sizes of the object to be detected TO1, the object to be detected TO2 and the object to be detected TO3 are small, a microscope is generally required to magnify the objects to be detected, so that the image to be detected P1 may be an magnified image. That is, the sizes of the object to be detected TO1, the object to be detected TO2 and the object to be detected TO3 in the image to be detected P1 are respectively multiples of their actual sizes. The specific value of the multiple is related to the parameters of the device for obtaining the image to be detected P1. For example, considering an example in which the device for obtaining the image to be detected P1 is a camera, the specific value of the multiple may be related to the focal length of the camera. The specific value of the multiple is not limited in the present disclosure.

In step 102, a reference region and a region of an object to be detected are obtained based on the image to be detected.

For example, as shown in FIG. 2, the image to be detected P1 may further include the reference region RL, and the region of the object to be detected may be any one or more of a region of the object to be detected TO1, a region of the object to be detected TO2, and a region of the object to be detected TO3. For example, the reference region RL, the region of the object to be detected TO1, the region of the object to be detected TO2, and the region of the object to be detected TO3 are almost parallel to each other. It will be understood that, considering an example in which the object to be detected is the adhesive on the array substrate, the reference region RL may be a structure in the array substrate that is almost parallel to the adhesive and has a clear contour and color. For example, the reference region RL may be a region of a certain conductive line in the array substrate, and the color of the conductive line is different from the color of the adhesive on the array substrate.

For example, the reference region RL serves as a reference for measuring distance. To measure the distance from the region of the object to be detected to the reference region RL, it is first necessary to identify the reference region RL, the region of the object to be detected TO1, the region of the object to be detected TO2, and the region of the object to be detected TO3 that in the image to be detected P1.

In some embodiments, the regions of multiple objects to be detected in the image to be detected P1 may be located on the same side of the reference region RL. For example, as shown in FIG. 2, in the image to be detected P1, the region of the object to be detected TO1, the region of the object to be detected TO2, and the region of the object to be detected TO3 are all located on the left side of the reference region RL. The following embodiments will be described by taking an example in which the region of the object to be detected TO1, the region of the object to be detected TO2 and the region of the object to be detected TO3 are all located on the left side of the reference region RL in the image to be detected P1.

For example, considering an example in which the reference region is located in the right region of the image to be detected P1 and the region of the object to be detected is located in the left region of the image to be detected P1, as shown in FIG. 2, the image to be detected P1 may be divided into the left region and right region, the reference region RL is obtained based on the right region of the image to be detected P1, and the region of the object to be detected TO1, the region of the object to be detected TO2 and the region of the object to be detected TO3 are obtained based on the left region of the reference region RL, so as to reduce the amount of calculation.

In some embodiments, the implementation of obtaining the reference region based on the image to be detected includes: performing a binarization processing on the image to be detected to obtain the reference region. Considering an example in which the reference region RL is a region of a certain conductive line in the array substrate, since the color of the conductive line is different from the color of the adhesive on the array substrate, and the outline of the conductive line is clear, in the image to be detected P1, the grayscale value of the color of the reference region RL is greatly different from the grayscale value of the color of the object to be detected. Thus, by means of the manner of the binarization, it is possible to identify the reference region RL in the image to be detected P1 quickly and simply, which may ensure high identification accuracy as well as a small amount of calculation.

For example, the implementation of obtaining the reference region based on the image to be detected includes: obtaining the reference region based on the image to be detected or a neural network algorithm. The specific manner of obtaining the reference region is not limited in the present disclosure. By means of the manner of the binarization, the reference region may be obtained more simply and quickly, and the amount of calculation is reduced.

In some embodiments, the implementation of obtaining the region of the object to be detected based on the image to be detected includes: obtaining the region of the object to be detected based on the image to be detected and a neural network algorithm. For example, the neural network algorithm includes a manner of semantic segmentation, which accurately segments the image by determining the category of each pixel in the image. Considering an example in which the object to be detected is the adhesive on the array substrate, in the image to be detected, the texture background of the adhesive is relatively complex. By means of the manner of semantic segmentation, the region of the object to be detected may be accurately identified.

For example, the region of the object to be detected may be obtained by means of the U-Net network. The U-Net network includes a contracting path and an expanding path, and the two paths are symmetrical with each other, the overall structure of which is similar to the capital letter U, so that it is named as U-Net. The U-Net network may also be referred to as an encoder-decoder structure. For example, the contraction path of the U-Net network is used to obtain context information. The U-Net network adopts the typical architecture of a convolutional network and includes four down sampling layers. Each layer performs two consecutive 3×3 convolutions on the feature map input by the previous layer, and rectified linear unit (ReLU) is used for activation. 2×2 maximum pooling is used for down sampling, and the number of channels is gradually increased. The expanding path in the U-Net structure is used for precise positioning, which includes four up sampling layers. Each layer uses deconvolution to double the up sampling on the feature map input by the previous layer to restore the compressed features. The feature map of the encoder symmetric path is skip-connected for channel merging, and the merged feature map is subjected to two 3×3 convolutions and the ReLU activation function, and is sent to the next layer. In the last layer, a 1×1 convolutional layer is used to map the feature vectors to the required number of categories.

In step 103, a reference line is obtained based on the reference region.

For example, the reference line is used to locate the reference region. Since the reference region RL is magnified in the image to be detected P1, the reference region RL is a region with a contour in the image to be detected P1. In a case where the distance measurement is required, the reference line may be used to represent the location of the reference region RL.

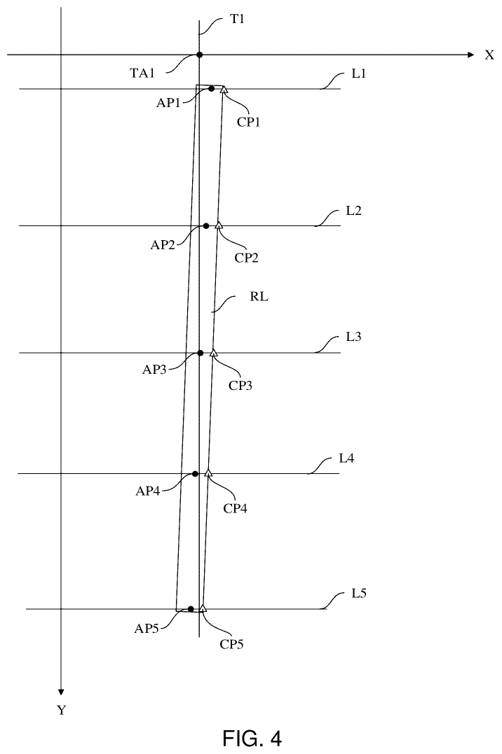

In some embodiments, the reference line is parallel to a first direction. As shown in FIGS. 2 and 4, a two-dimensional coordinate system is established with the upper left vertex of the image to be detected P1 as the origin, a direction from the upper side to the right side of the image to be detected P1 as a positive direction of an X-axis, and a direction from the left side to the lower side of the image to be detected P1 as a positive direction of a Y-axis. Considering an example in which a direction of the Y-axis is the first direction, the reference region RL is almost parallel to the Y-axis. Therefore, a straight line parallel to the first direction, i.e. the reference line T1 parallel to the Y-axis, is used to locate the reference region RL.

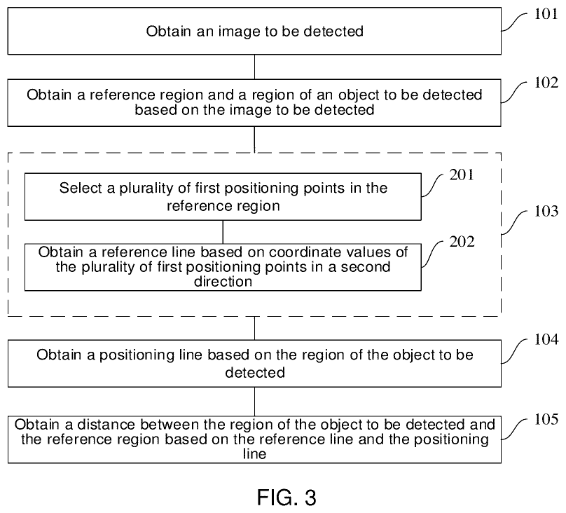

For example, as shown in FIG. 3, the implementation of the step 103 includes steps 201 to 202.

In step 201, a plurality of first positioning points are selected in the reference region.

It will be understood that the localization of the reference region RL may be accurate by selecting the plurality of first positioning points. The number of first positioning points selected in the reference region RL is not limited in the present disclosure. The following embodiments will be described by taking an example in which 5 first positioning points are selected in reference region RL. For example, as shown in FIG. 4, five first positioning points (e.g., first positioning points AP1, AP2, AP3, AP4 and AP5) are selected in the reference region RL, and the five first positioning points are respectively located at the top, ¼, ½, ¾ and bottom positions of the reference region RL along the Y axis.

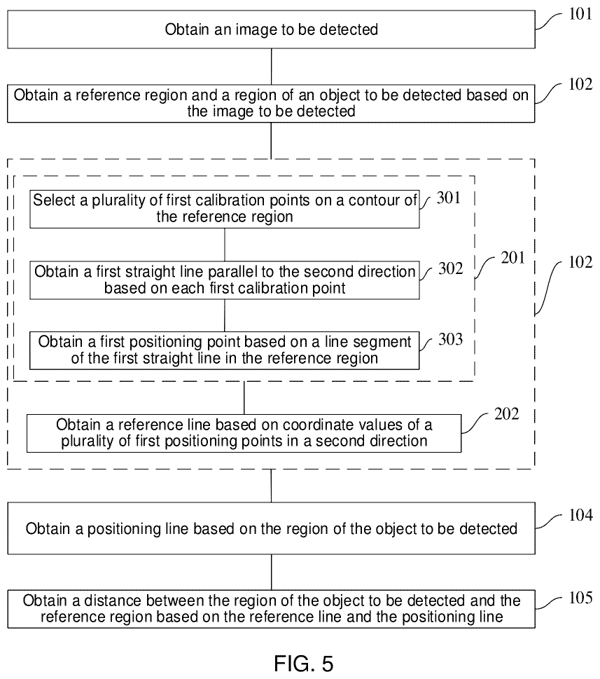

For example, as shown in FIG. 5, the implementation of the step 201 includes steps 301 to 303.

In step 301, a plurality of first calibration points are selected on the contour of the reference region.

The plurality of first calibration points are respectively located at the top end, the bottom end, and at least one intermediate position between the top end and the bottom end of the contour of the reference region. For example, as shown in FIG. 4, five first calibration points (e.g., first calibration points CP1, CP2, CP3, CP4 and CP5) are selected on the contour of the reference region RL, and the five first calibration points are respectively located at the top, ¼, ½, ¾ and bottom positions of contour of the reference region RL along the Y axis.

In step 302, a first straight line parallel to a second direction is obtained based on each first calibration point.

For example, as shown in FIG. 4, the second direction is perpendicular to the first direction; considering an example in which the direction of the X-axis is the second direction, first straight lines (e.g., first straight lines L1, L2, L3, L4 and L5) parallel to the second direction are obtained based on all the first calibration points.

In step 303, a first positioning point is obtained based on a line segment of the first straight line in the reference region.

For example, as shown in FIG. 4, the first positioning point is the midpoint of the line segment of the first straight line in the reference region. Considering an example in which the first positioning point is the first positioning point AP1 and the first straight line is the first straight line L1, the first positioning point AP1 is the midpoint of the line segment of the first straight line L1 in the reference region RL.

Through the steps 301 to 303, different calibration points are selected at different positions of the reference region RL in the first direction (Y-axis) to select different positioning points at different positions of the reference region RL in the first direction (Y-axis), and the midpoint of the line segment of the first straight line in the reference region is selected as the first positioning point, so that the positions of the selected first positioning points in the second direction (X-axis) are not the same. Therefore, it is possible to locate the reference region RL accurately through the reference line T1.

In step 202, the reference line is obtained based on coordinate values of the plurality of first positioning points in the second direction.

A coordinate value of the reference line in the second direction is an average of the coordinate values of the plurality of first positioning points in the second direction.

For example, in the image to be detected P1, there may be differences between the coordinate values of all points in the reference region RL in the second direction (X-axis); by taking the average of the coordinate values of the plurality of points in the reference region RL in the second direction (X-axis), the reference line may be used to accurately locate the reference region RL.

For example, as shown in FIG. 4, the coordinate value of the reference line T1 in the second direction is a coordinate value, on the X-axis, of an intersection point TA1 of the reference line T1 and the X-axis. The coordinate value, on the X-axis, of the intersection point TA1 of the reference line T1 and the X-axis is the average of the coordinate values, on the X-axis, of the five first positioning points (first positioning points AP1, AP2, AP3, AP4 and AP5).

In step 104, a positioning line is obtained based on the region of the object to be detected.

For example, the positioning line is used to locate the region of the object to be detected. Since the object to be detected TO1, the object to be detected TO2 and the object to be detected TO3 are magnified in the image to be detected P1, the region of the object to be detected is a region with a contour in the image to be detected P1. In a case where the distance measurement is required, the positioning line may be used to represent the position of the region of the object to be detected. In some embodiments, the positioning line is parallel to the first direction; the implementation of the step 104 includes: firstly, selecting a plurality of second positioning points in the region of the object to be detected; and then, obtaining the positioning line based on coordinate values of the plurality of second positioning points in the second direction. The second direction is perpendicular to the first direction; a coordinate value of the positioning line in the second direction is an average of the coordinate values of the plurality of second positioning points in the second direction. The method is similar to the method of obtaining the reference line described in the steps 201 to 202, and will not be repeated here.

In some embodiments, the region of the object to be detected includes at least two sub-regions. For example, the region of the object to be detected includes a first sub-region and a second sub-region, and the positioning line includes a first positioning sub-line and a second positioning sub-line. The first positioning sub-line is used to locate the first sub-region, and the second positioning sub-line is used to locate the second sub-region. It will be understood that the region of the object to be detected may further include a third sub-region, a fourth sub-region and a fifth sub-region. Considering an example in which the object to be detected is the adhesive on the array substrate, in the image to be detected P1, for example, the region of the object to be detected may be divided into a plurality of sub-regions based on the identified contour of the object to be detected, and a distance between the adhesive and the reference region is obtained based on the distances between the plurality of sub-regions and the reference region, so as to make the distance measurement result is accurate. The number of sub-regions included in the region of the object to be detected and the method of obtaining each sub-region are not limited in the present disclosure.

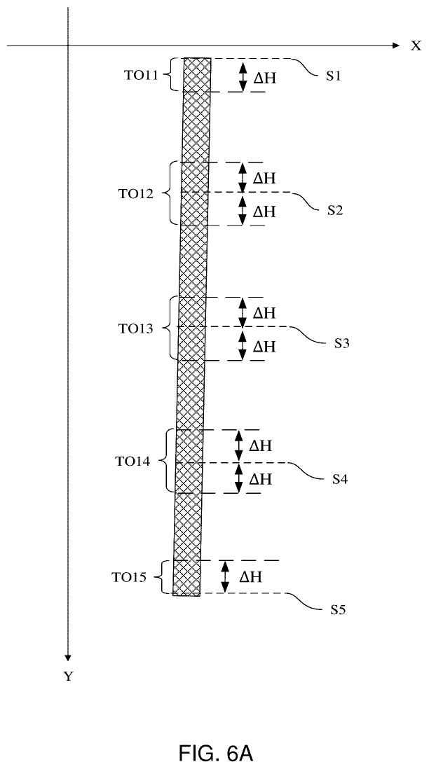

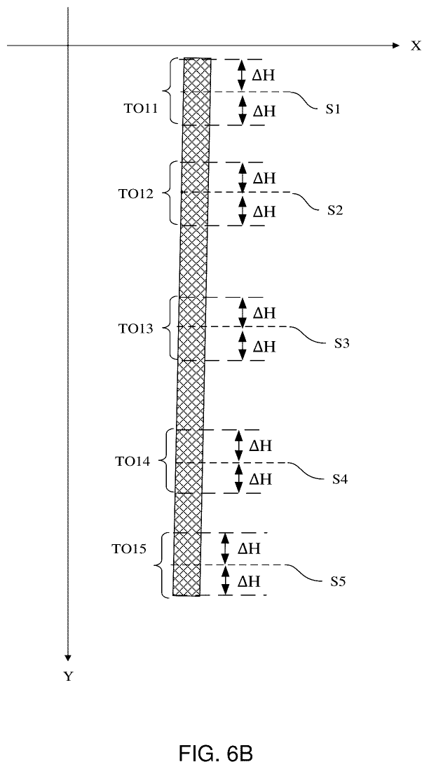

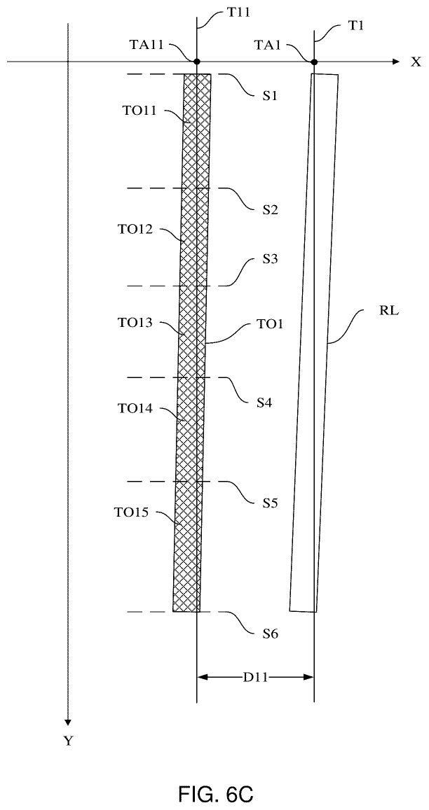

For example, as shown in FIG. 6A, considering an example in which the object to be detected is the object to be detected TO1, based on the identified contour of the object to be detected TO1, five boundaries (e.g., boundaries S1, S2, S3, S4 and S5) parallel to the X-axis are selected at the top, ¼, ½, ¾ and bottom positions of the contour of the object to be detected TO1 along the Y-axis. It will be understood that in a case where the boundary S1 is the top boundary, the boundary S5 is the bottom boundary; in a case where the boundary S5 is the top boundary, the boundary S1 is the bottom boundary. The top and bottom of the object to be detected TO1 is not limited in the present disclosure. The following embodiments will be described by taking an example in which the boundary S1 is the top boundary and the boundary S5 is the bottom boundary. A region downwards a height of ΔH from the top boundary S1 is selected as a first sub-region TO11, and a region respectively upwards and downwards a height of ΔH from the boundary S2 at the ¼ position as the center is selected as a second sub-region TO12, a region respectively upwards and downwards a height of ΔH from the boundary S3 at the ½ position as the center is selected as a third sub-region TO13, a region respectively upwards and downwards a height of ΔH from the boundary S4 at the ¾ position as the center is selected as a fourth sub-region TO14, and a region upwards a height of ΔH from the bottom boundary S5 is selected as a fifth sub-region TO15. For example, as shown in FIG. 6B, the component, on the Y-axis, of the distance between the top boundary S1 and the top of the contour of the object to be detected TO1 may be ΔH, and a region respectively upwards and downwards a height of ΔH from the top boundary S1 as the center is selected as the first sub-region TO11; the component, on the Y-axis, of the distance between the bottom boundary S5 and the bottom of the contour of the object to be detected TO1 may be ΔH, and a region respectively upwards and downwards a height of ΔH from the bottom boundary S5 as the center is selected as the fifth sub-region TO15. The specific value and measurement unit of ΔH are not limited in the present disclosure. The specific value of ΔH may be adjusted according to actual application conditions. For example, the measurement unit of ΔH may be a unit of length (for example, ΔH may be 1 millimeter) or a pixel unit (for example, ΔH may be 20 pixels).

For example, M boundaries parallel to the first direction (X-axis) may also be selected in the region of the object to be detected TO1, where M is an integer greater than or equal to 3. The M boundaries divide the region of the object to be detected TO1 into M−1 sub-regions. The M−1 sub-regions are distributed at different positions in the direction of the Y-axis, so as to obtain the distance between the region of the object to be detected TO1 and the reference region at different positions on the Y-axis. The positions of the M boundaries on the Y-axis are not limited in the present disclosure. For example, the M boundaries may divide the region of the object to be detected TO1 into M−1 sub-regions equally along the Y-axis, and the M−1 sub-regions have a substantially the same height along the Y axis. For another example, the M−1 sub-regions divided by the M boundaries have different heights along the Y-axis.

For example, as shown in FIG. 6C, considering an example in which the region of the object to be detected is the region of the object to be detected TO1, and the value of M is 6, 6 boundaries (e.g., boundaries S1, S2, S3, S4, S5 and S6) are selected in the region of the object to be detected TO1, and the 6 boundaries divide the region of the object to be detected TO1 into five sub-regions. For example, a region where the object to be detected TO1 is located between the boundary S1 and the boundary S2 serves as the first sub-region TO11, the region where the object is to be detected TO1 is located between the boundary S2 and the boundary S3 serves as the second sub-region TO12, the region where the object to be detected TO1 is located between the boundary S3 and the boundary S4 serves as the third sub-region TO13, the region where the object to be detected TO1 is located between the boundary S4 and the boundary S5 serves as the fourth sub-region TO14, and the region where the object is to be detected TO1 is located between the boundary S5 and the boundary S6 serves as the fifth sub-region TO15.

As shown in FIG. 2, the region of the object to be detected TO1 is almost parallel to the Y-axis. Similar to the principle of using the reference line T1 to locate the reference region RL, a straight line parallel to the first direction may be used to locate the region of the object to be detected TO1.

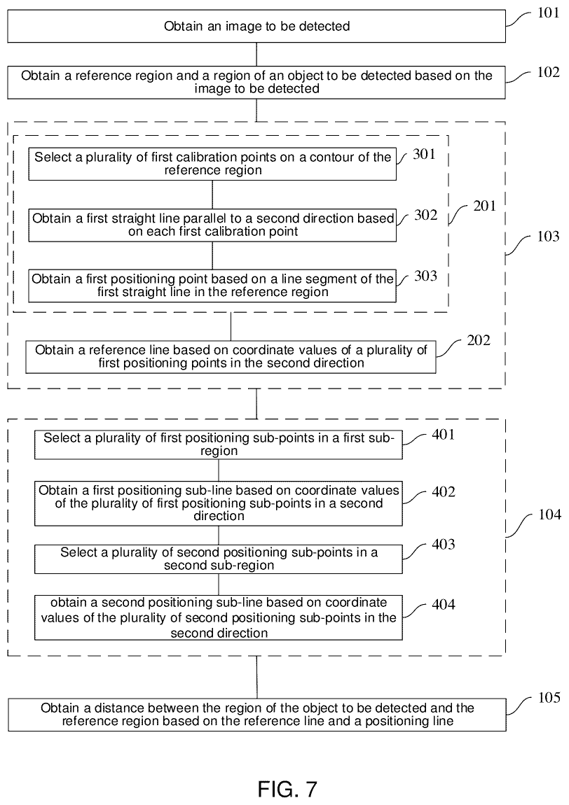

As shown in FIG. 7, the implementation of the step 104 includes steps 401 to 404.

In step 401, a plurality of first positioning sub-points are selected in the first sub-region.

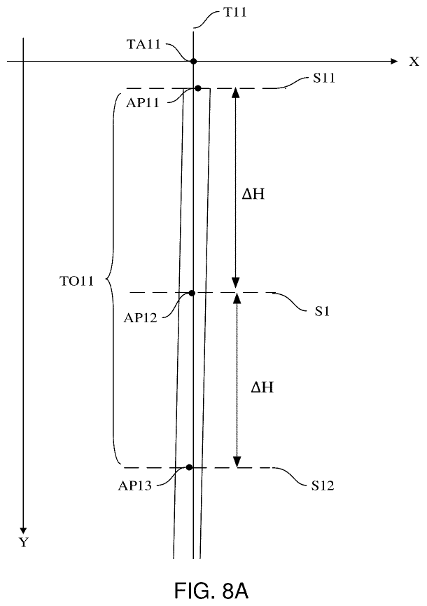

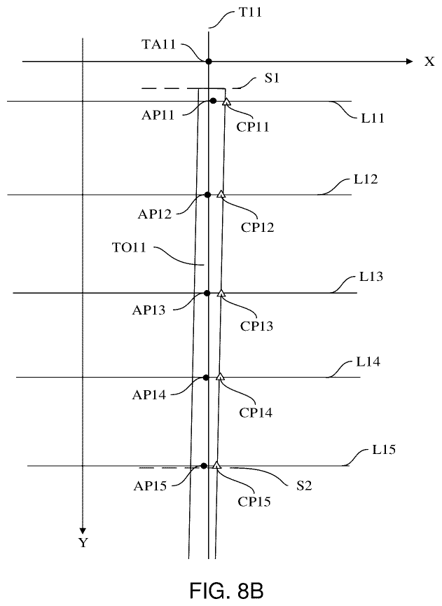

For example, as shown in FIGS. 6B and 8A, three positioning sub-points (e.g., positioning sub-points AP11, AP12 and AP13) may be selected in the first sub-region TO11. The first positioning sub-point AP11 is the midpoint of the line segment of the boundary S11 in the first sub-region TO11, and the boundary S11 is the top boundary of the first sub-region TO11. The first positioning sub-point AP12 is the midpoint of the line segment of the boundary S1 in the first sub-region TO11. The first positioning sub-point AP13 is the midpoint of the line segment of the boundary S12 in the first sub-region TO11, and the boundary S12 is the bottom boundary of the first sub-region TO11.

For example, as shown in FIGS. 6C and 8B, five first positioning sub-points (e.g., first positioning sub-points AP11, AP12, AP13, AP14 and AP15) are selected in the first sub-region TO11, and the five first positioning sub-points are respectively located at the top, ¼, ½, ¾ and bottom positions of the first sub-region TO11 along the Y axis.

In some embodiments, as shown in FIGS. 4 and 8B, the step 401 is implemented in the same way as the steps 301 to 303.

Firstly, a plurality of second calibration points are selected on a contour of the first sub-region. For example, as shown in FIG. 8B, the contour of the first sub-region TO11 is a contour of part of the region of the object to be detected TO1 located between the boundary S1 and the boundary S2. Five second calibration points (e.g., second calibration points CP11, CP12, CP13, CP14 and CP15) are selected on the contour of the first sub-region TO11, and the five second calibration points are respectively located at the top, ¼, ½, ¾, and the bottom positions of the contour of the first sub-region TO11 along the Y-axis.

Secondly, a second straight line parallel to the second direction is obtained based on each second calibration point. For example, as shown in FIG. 8B, second straight lines (e.g., second straight lines L11, L12, L13, L14 and L15) parallel to the second direction are obtained based on all the second calibration points.

Then, the first positioning sub-points are obtained based on the line segments of the second straight lines in the first sub-region. For example, as shown in FIG. 8B, the first positioning sub-point is the midpoint of the line segment of the second straight line in the first sub-region. Considering an example in which the first positioning sub-point is the first positioning sub-point AP11 and the second straight line is the second straight line L11, the first positioning sub-point AP11 is the midpoint of the line segment of the second straight line L11 in the first sub-region T011.

In step 402, the first positioning sub-line is obtained based on coordinate values of the plurality of first positioning sub-points in the second direction.

A coordinate value of the first positioning sub-line in the second direction is an average of the coordinate values of the plurality of first positioning sub-points in the second direction. For example, in the image to be detected P1, there may be differences between the coordinate values of all points in the first sub-region TO11 in the second direction (X-axis); by taking the average of the coordinate values of the plurality of points in the first sub-region T011 in the second direction (X-axis), the first positioning sub-line T11 may be used to accurately locate the first sub-region T011.

For example, as shown in FIG. 8A, the coordinate value of the first positioning sub-line T11 in the second direction (i.e., the coordinate value, on the X-axis, of the intersection point TA11 of the first positioning sub-line T11 and the X-axis) is the average value of the coordinate values of the three first positioning sub-points (first positioning sub-points AP11, AP12 and AP13) on the X-axis.

For example, as shown in FIG. 8B, the coordinate value of the first positioning sub-line T11 in the second direction (i.e., the coordinate value, on the X-axis, of the intersection point TA11 of the first positioning sub-line T11 and the X-axis) is the average value of the coordinate values of the five first positioning sub-points (first positioning sub-points AP11, AP12, AP13, AP14, and AP15) on the X-axis.

In step 403, a plurality of second positioning sub-points are selected in the second sub-region.

It will be understood that the process of the step 403 is the same as the process of the step 401, and will not be repeated here.

In step 404, the second positioning sub-line is obtained based on coordinate values of the plurality of second positioning sub-points in the second direction.

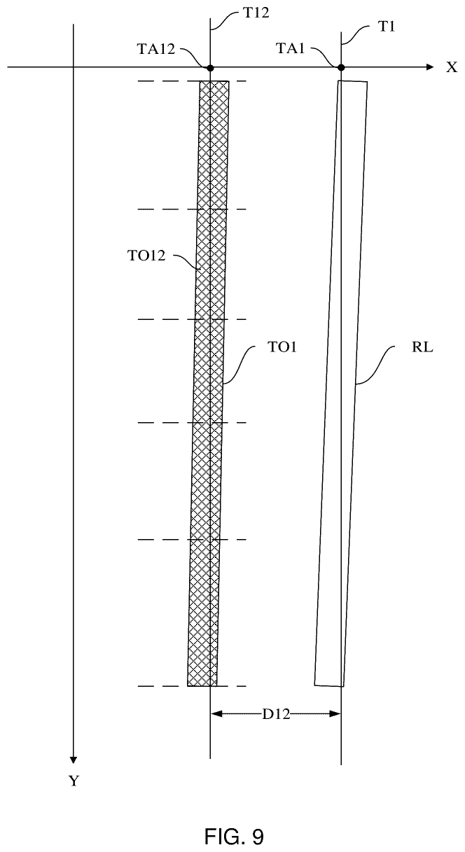

It will be understood that the process of the step 404 is the same as the process of the step 402, and will not be repeated here. As shown in FIG. 9, the second positioning sub-line T12, and the coordinate value of the second positioning sub-line T12 in the second direction (i.e., the coordinate value, on the X-axis, of an intersection point TA12 of the second positioning sub-line T12 and the X-axis) are obtained through the steps 403 and 404.

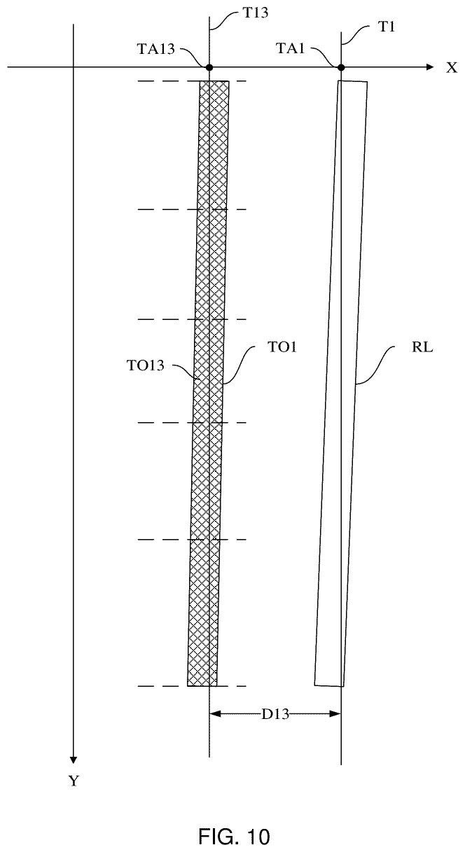

For example, as shown in FIG. 10, in the third sub-region TO13, steps 401 and 402 or steps 403 to 404 are repeatedly executed to obtain a third positioning sub-line T13 and a coordinate value of the third positioning sub-line T13 in the second direction, i.e., a coordinate value, on the X-axis, of an intersection point TA13 of the third positioning sub-line T13 and the X-axis.

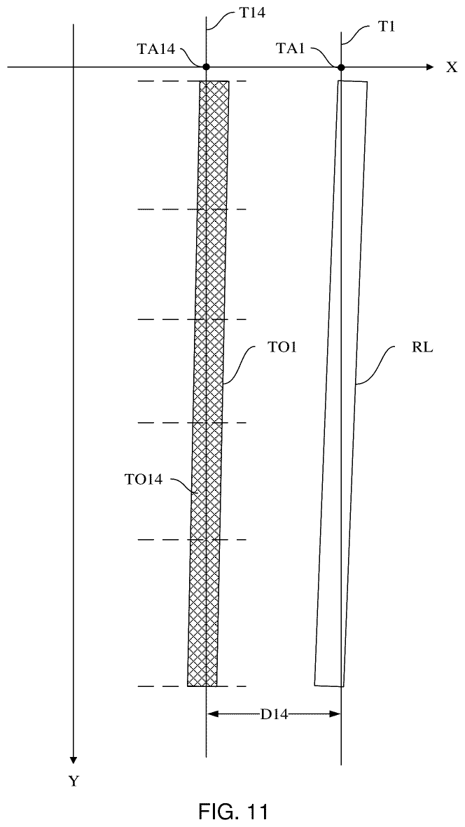

For example, as shown in FIG. 11, in the fourth sub-region TO14, steps 401 and 402 or steps 403 to 404 are repeatedly executed to obtain a fourth positioning sub-line T14 and a coordinate value of the fourth positioning sub-line T14 in the second direction, i.e., a coordinate value, on the X-axis, of an intersection point TA14 of the fourth positioning sub-line T14 and the X-axis.

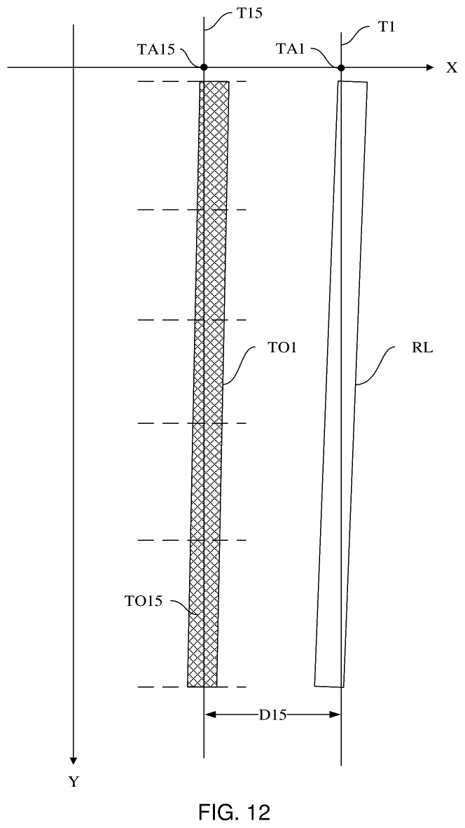

For example, as shown in FIG. 12, in the fifth sub-region TO15, steps 401 and 402 or steps 403 to 404 are repeatedly executed to obtain a fifth positioning sub-line T15 and a coordinate value of the fifth positioning sub-line T15 in the second direction, i.e., a coordinate value, on the X-axis, of an intersection point TA15 of the fifth positioning sub-line T15 and the X-axis.

In step 105, a distance between the region of the object to be detected and the reference region is obtained based on the reference line and the positioning line.

It will be understood that the reference line is used to represent the position of the reference region RL, and the positioning line is used to represent the position of the region of the object to be detected, then the distance between the reference line and the positioning line may represent the distance between the reference region RL and the region of the object to be detected.

The distance between the reference region RL and the region of the object to be detected refers to a distance between the reference region RL and a region of a certain object to be detected. For example, as shown in FIG. 2, the distance between the reference region RL and the region of the object to be detected may refer to a distance between the reference region RL and the region of the object to be detected TO1, or may refer to a distance between the reference region RL and the region of the object to be detected TO2, or may refer to a distance between the reference region RL and the region of the object to be detected TO3.

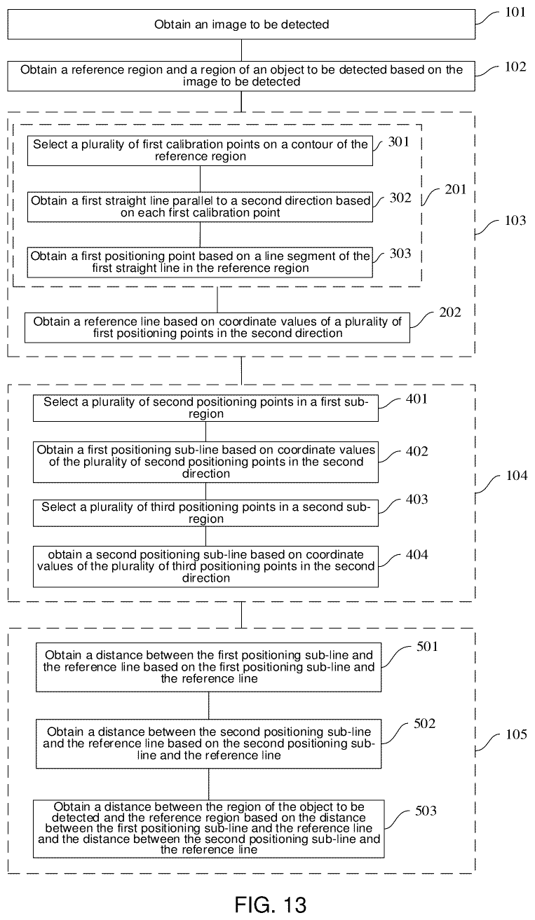

In some embodiments, as shown in FIG. 13, the implementation of the step 105 includes steps 501 to 503.

In step 501, a distance between the first positioning sub-line and the reference line is obtained based on the first positioning sub-line and the reference line.

For example, as shown in FIGS. 4 and 8B, considering an example in which the coordinate value, on the X-axis, of the intersection point TA11 of the first positioning sub-line T11 and the X-axis is x1, and the coordinate value, on the X-axis, of the intersection point TA1 of the reference line T1 and the X-axis is x0, the distance D11 between the first positioning sub-line T11 and the reference line T1 may be calculated by the formula D11=|x0−x1|.

In step 502, a distance between the second positioning sub-line and the reference line is obtained based on the second positioning sub-line and the reference line.

For example, as shown in FIGS. 4 and 9, considering an example in which the coordinate value, on the X-axis, of the intersection point TA12 of the second positioning sub-line T12 and the X-axis is ×2, and the coordinate value, on the X-axis, of the intersection point TA1 of the reference line T1 and the X-axis is ×0, the distance D12 between the second positioning sub-line T12 and the reference line T1 may be calculated by the formula D12=|x0−x2|.

It will be understood that, as shown in FIG. 6C, the region of the object to be detected TO1 further includes a third sub-region TO13, a fourth sub-region TO14, and a fifth sub-region TO15. As shown in FIGS. 10 to 12, step 501 or step 502 are repeatedly executed to obtain a distance D13 between the third positioning sub-line T13 and the reference line T1, a distance D14 between the fourth positioning sub-line T14 and the reference line T1, and a distance D15 between the fifth positioning sub-line T15 and the reference line T1.

In step 503, the distance between the region of the object to be detected and the reference region is obtained based on the distance between the first positioning sub-line and the reference line and the distance between the second positioning sub-line and the reference line.

For example, as shown in FIG. 6C and FIGS. 9 to 12, considering an example in which the distance between the region of the object to be detected TO1 and the reference region RL is D1, the calculation formula of D1 may be

$$D 1 = \frac{D 11 + D 12 + D 13 + D 14 + D 15}{5} .$$

It will be understood that the region of the object to be detected may include N sub-regions, where N is an integer greater than or equal to 1. Considering an example in which the distance between the region of the object to be detected and the reference region is DN, the calculation formula of DN may be

$$DN = \frac{{{\sum }^{N}}_{i = 1} D 1 i}{N} ,$$

where D1i is the distance between the i-th sub-region and the reference region, and i is an integer between 1 and N, inclusive.

In the method provided by the above embodiments, the region of the object to be detected is divided into a plurality of sub-regions in the first direction (Y-axis), the distance between each sub-region and the reference region is obtained, and then the average value of the obtained distances each between a sub-region and the reference region is calculated, and the average value is the distance between the region of the object to be detected and the reference region. The method may reduce the impact of the deviation that exists in a case where the neural network method is used to obtain the region of the object to be detected, and by using the method, it is possible to accurately locate the sub-region of the object to be detected through the positioning sub-line, thereby improving the accuracy of the distance between the region of the object to be detected and the reference region. In addition, the method may realize automatic measurement to improve the measurement efficiency, thereby improving the generation efficiency.

Some embodiments of the present disclosure provide a computer-readable storage medium (e.g., a non-transitory computer-readable storage medium), the computer-readable storage medium has stored a computer program instruction, and the computer program instruction, when executed on a computer (e.g., a distance measurement apparatus), causes the computer to perform the distance measurement apparatus for the electronic device according to any of the above embodiments.

For example, the computer-readable storage medium may include, but is not limited to, a magnetic storage device (e.g., a hard disk, a floppy disk or a magnetic tape), an optical disk ((e.g., a compact disk (CD) or a digital versatile disk (DVD)), a smart card and a flash memory device (e.g., an erasable programmable read-only memory (EPROM), a card, a stick or a key driver). Various computer-readable storage media described in the present disclosure may represent one or more devices and/or other machine-readable storage medium for storing information. The term “computer-readable storage medium” may include, but is not limited to, wireless channels and various other media capable of storing, containing and/or carrying instructions and/or data.

Some embodiments of the present disclosure provide a computer program product, which is stored on, for example, a non-transitory computer-readable storage medium. The computer program product includes computer program instructions, and when the computer program instructions are executed on a computer (e.g., a distance measurement apparatus), the computer program instructions cause the computer to perform the distance measurement method according to the foregoing embodiments.

Some embodiments of the present disclosure provide a computer program. When executed by a computer (e.g., a distance measurement apparatus), the computer program causes the computer to perform the distance measurement method as described in the above embodiments.

Beneficial effects of the computer-readable storage medium, the computer program product, and the computer program are same as the beneficial effects of the distance measurement method as described in some embodiments described above, and details will not be repeated here.

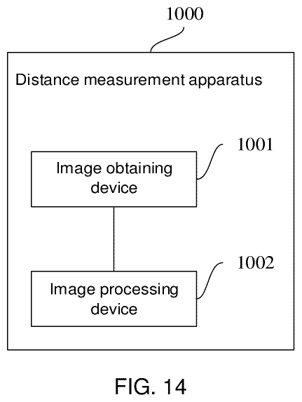

Some embodiments of the present disclosure provide a distance measurement apparatus, as shown in FIG. 14, the distance measurement apparatus 1000 includes an image obtaining device 1001 and an image processing device 1002. The image obtaining device 1001 is coupled to the image processing device 1002 and configured to obtain an image to be detected; the image to be detected includes at least one object to be detected. For example, the image obtaining device 1001 may be a camera.

In some embodiments, region(s) of the at least one object to be detected are located on the same side of a reference region. For example, as shown in FIG. 2, regions of an object to be detected TO1, an object to be detected TO2 and an object to be detected TO3 are located on the left side of the reference region RL.

The image processing device 1002 is configured to: obtain the reference region and the region of the object to be detected based on the image to be detected; obtain a reference line based on the reference region, the reference line being used to locate the reference region; obtain a positioning line based on the region of the object to be detected, the positioning line being used to locate the region of the object to be detected; and obtain a distance between the region of the object to be detected and the reference region based on the reference line and the positioning line.

In some embodiments, the image processing device 1002 is configured to perform a binarization processing on the image to be detected to obtain the reference region.

In some embodiments, the image processing device 1002 is configured to: obtain the region of the object to be detected based on the image to be detected and a neural network algorithm.

In some embodiments, the reference line is parallel to the first direction, and the image processing device 1002 is configured to: firstly, select a plurality of first positioning points in the reference region; and then, obtain the reference line based on coordinate values of the plurality of first positioning points in the second direction, the second direction being perpendicular to the first direction, and the coordinate value of the reference line in the second direction being an average of the coordinate values of the plurality of first positioning points in the second direction.

In some embodiments, the image processing device 1002 is configured to: firstly, select a plurality of first calibration points on a contour of the reference region, the plurality of first calibration points being respectively located at the top, bottom, and at least one intermediate position between the top and bottom of the contour of the reference region; secondly, obtain a first straight line parallel to the second direction based on each first calibration point; and then, obtain the first positioning point based on a line segment of the first straight line in the reference region, the first positioning point being the midpoint of the line segment of the first straight line in the reference region.

In some embodiments, the positioning line is parallel to the first direction; the region of the object to be detected includes a first sub-region and a second sub-region; the positioning line includes a first positioning sub-line and a second positioning sub-line, the first positioning sub-line is used to locate the first sub-region, and the second positioning sub-line is used to locate the second sub-region. The image processing device 1002 is configured to: firstly, select a plurality of first positioning sub-points in the first sub-region; secondly, obtain the first positioning sub-line based on coordinate values of the plurality of first positioning sub-points in the second direction, the coordinate value of the first positioning sub-line in the second direction being an average of the coordinate values of the plurality of first positioning sub-points in the second direction; thirdly, a plurality of second positioning sub-points are selected in the second sub-region; and then, obtain the second positioning sub-line based on coordinate values of the plurality of second positioning sub-points in the second direction, the coordinate value of the second positioning sub-line in the second direction being an average of the coordinate values of the plurality of second positioning sub-points in the second direction.

In some embodiments, the image processing device 1002 is configured to: firstly, obtain a distance between the first positioning sub-line and the reference line based on the first positioning sub-line and the reference line; secondly, obtain a distance between the second positioning sub-line and the reference line based on the second positioning sub-line and the reference line; and then, obtain the distance between the region of the object to be detected and the reference region based on the distance between the first positioning sub-line and the reference line and the distance between the second positioning sub-line and the reference line.

The above are only specific embodiments of the present disclosure, but the scope of protection of the present disclosure is not limited thereto, and any person skilled in the art may conceive of variations or replacements within the technical scope of the present disclosure, which shall fall within the protection scope of the present disclosure. Therefore, the protection scope of the present disclosure should be determined by the protection scope of the claims.

1. A distance measurement method, comprising:
obtaining an image to be detected, the image to be detected including at least one object to be detected;
obtaining a reference region and a region of an object to be detected based on the image to be detected;
obtaining a reference line based on the reference region, the reference line being used to locate the reference region;
obtaining a positioning line based on the region of the object to be detected, the positioning line being used to locate the region of the object to be detected; and
obtaining a distance between the region of the object to be detected and the reference region based on the reference line and the positioning line.

2. The distance measurement method according to claim 1, wherein the reference line is parallel to a first direction; obtaining the reference line based on the reference region includes:
selecting a plurality of first positioning points in the reference region; and
obtaining the reference line based on coordinate values of the plurality of first positioning points in a second direction, the second direction being perpendicular to the first direction, and a coordinate value of the reference line in the second direction being an average of the coordinate values of the plurality of first positioning points in the second direction.

3. The distance measurement method according to claim 2, wherein selecting the plurality of first positioning points in the reference region includes:
selecting a plurality of first calibration points on a contour of the reference region, the plurality of first calibration points being respectively located at top, bottom, and at least one intermediate position between the top and bottom of the contour of the reference region;
obtaining a first straight line parallel to the second direction based on each first calibration point; and
obtaining respective a first positioning point of the plurality of first positioning points based on a line segment of the first straight line in the reference region, the first positioning point being a midpoint of the line segment of the first straight line in the reference region.

4. (canceled)

5. The distance measurement method according to claim 1, wherein the positioning line is parallel to a first direction; the region of the object to be detected includes a first sub-region and a second sub-region; the positioning line includes a first positioning sub-line and a second positioning sub-line, the first positioning sub-line is used to locate the first sub-region, and the second positioning sub-line is used to locate the second sub-region; obtaining the positioning line based on the region of the object to be detected includes:
selecting a plurality of first positioning sub-points in the first sub-region;
obtaining the first positioning sub-line based on coordinate values of the plurality of first positioning sub-points in a second direction, the second direction being perpendicular to the first direction, and a coordinate value of the first positioning sub-line in the second direction being an average of the coordinate values of the plurality of first positioning sub-points in the second direction;
selecting a plurality of second positioning sub-points in the second sub-region; and
obtaining the second positioning sub-line based on coordinate values of the plurality of second positioning sub-points in the second direction, a coordinate value of the second positioning sub-line in the second direction being an average of the coordinate values of the plurality of second positioning sub-points in the second direction.

6. The distance measurement method according to claim 5, wherein obtaining the distance between the region of the object to be detected and the reference region based on the reference line and the positioning line includes:
obtaining a distance between the first positioning sub-line and the reference line based on the first positioning sub-line and the reference line;
obtaining a distance between the second positioning sub-line and the reference line based on the second positioning sub-line and the reference line; and
obtaining the distance between the region of the object to be detected and the reference region based on the distance between the first positioning sub-line and the reference line and the distance between the second positioning sub-line and the reference line.

7. The distance measurement method according to claim 1, wherein the positioning line is parallel to a first direction; obtaining the positioning line based on the region of the object to be detected includes:
selecting a plurality of second positioning points in the region of the object to be detected; and
obtaining the positioning line based on coordinate values of the plurality of second positioning points in a second direction, the second direction being perpendicular to the first direction, and a coordinate value of the positioning line in the second direction being an average of the coordinate values of the plurality of second positioning points in the second direction.

8. The distance measurement method according to claim 1, wherein obtaining the reference region based on the image to be detected includes:
performing a binarization processing on the image to be detected to obtain the reference region.

9. The distance measurement method according to claim 1, wherein obtaining the region of the object to be detected based on the image to be detected includes:
processing the image to be detected based on a neural network algorithm to obtain the region of the object to be detected.

10. The distance measurement method according to claim 1, wherein a region of the at least one object to be detected is located on a same side of the reference region.

11-18. (canceled)

19. A non-transitory readable storage medium having stored thereon computer program instructions that, when executed on a computer, cause the computer to perform:
obtaining an image to be detected, the image to be detected including at least one object to be detected;
obtaining a reference region and a region of an object to be detected based on the image to be detected;
obtaining a reference line based on the reference region, the reference line being used to locate the reference region;
obtaining a positioning line based on the region of the object to be detected, the positioning line being used to locate the region of the object to be detected; and
obtaining a distance between the region of the object to be detected and the reference region based on the reference line and the positioning line.

20. A computer program product stored on a non-transitory computer-readable storage medium, comprising computer program instructions, wherein when the computer program instructions are executed on a computer, the computer program instructions cause the computer to perform the distance measurement method according to claim 1.

21. The non-transitory readable storage medium according to claim 19, wherein the reference line is parallel to a first direction; the computer program instructions cause the computer to perform:
selecting a plurality of first positioning points in the reference region; and
obtaining the reference line based on coordinate values of the plurality of first positioning points in a second direction, the second direction being perpendicular to the first direction, and a coordinate value of the reference line in the second direction being an average of the coordinate values of the plurality of first positioning points in the second direction.

22. The non-transitory readable storage medium according to claim 21, wherein the computer program instructions cause the computer to perform:
selecting a plurality of first calibration points on a contour of the reference region, the plurality of first calibration points being respectively located at top, bottom, and at least one intermediate position between the top and bottom of the contour of the reference region;
obtaining a first straight line parallel to the second direction based on each first calibration point; and
obtaining a respective first positioning point of the plurality of first positioning points based on a line segment of the first straight line in the reference region, the first positioning point being a midpoint of the line segment of the first straight line in the reference region.

23. The non-transitory readable storage medium according to claim 19, wherein the positioning line is parallel to a first direction; the region of the object to be detected includes a first sub-region and a second sub-region; the positioning line includes a first positioning sub-line and a second positioning sub-line, the first positioning sub-line is used to locate the first sub-region, and the second positioning sub-line is used to locate the second sub-region; the computer program instructions cause the computer to perform:
selecting a plurality of first positioning sub-points in the first sub-region;
obtaining the first positioning sub-line based on coordinate values of the plurality of first positioning sub-points in a second direction, the second direction being perpendicular to the first direction, and a coordinate value of the first positioning sub-line in the second direction being an average of the coordinate values of the plurality of first positioning sub-points in the second direction;
selecting a plurality of second positioning sub-points in the second sub-region; and
obtaining the second positioning sub-line based on coordinate values of the plurality of second positioning sub-points in the second direction, a coordinate value of the second positioning sub-line in the second direction being an average of the coordinate values of the plurality of second positioning sub-points in the second direction.

24. The non-transitory readable storage medium according to claim 23, the computer program instructions cause the computer to perform:
obtaining a distance between the first positioning sub-line and the reference line based on the first positioning sub-line and the reference line;
obtaining a distance between the second positioning sub-line and the reference line based on the second positioning sub-line and the reference line; and
obtaining the distance between the region of the object to be detected and the reference region based on the distance between the first positioning sub-line and the reference line and the distance between the second positioning sub-line and the reference line.

25. The non-transitory readable storage medium according to claim 19, wherein the positioning line is parallel to a first direction; the computer program instructions cause the computer to perform:
selecting a plurality of second positioning points in the region of the object to be detected; and
obtaining the positioning line based on coordinate values of the plurality of second positioning points in a second direction, the second direction being perpendicular to the first direction, and a coordinate value of the positioning line in the second direction being an average of the coordinate values of the plurality of second positioning points in the second direction.

26. The non-transitory readable storage medium according to claim 19, wherein the computer program instructions cause the computer to perform:
performing a binarization processing on the image to be detected to obtain the reference region.

27. The non-transitory readable storage medium according to claim 19, wherein the computer program instructions cause the computer to perform:
obtaining the region of the object to be detected based on the image to be detected and a neural network algorithm.

28. The computer program product according to claim 20, wherein the reference line is parallel to a first direction; the computer program instructions cause the computer to perform:
selecting a plurality of first positioning points in the reference region; and
obtaining the reference line based on coordinate values of the plurality of first positioning points in a second direction, the second direction being perpendicular to the first direction, and a coordinate value of the reference line in the second direction being an average of the coordinate values of the plurality of first positioning points in the second direction.

29. The computer program product according to claim 28, wherein the computer program instructions cause the computer to perform:
selecting a plurality of first calibration points on a contour of the reference region, the plurality of first calibration points being respectively located at top, bottom, and at least one intermediate position between the top and bottom of the contour of the reference region;
obtaining a first straight line parallel to the second direction based on each first calibration point; and
obtaining a respective first positioning point of the plurality of first positioning points based on a line segment of the first straight line in the reference region, the first positioning point being a midpoint of the line segment of the first straight line in the reference region.
